(19) United States
(12) Patent Application Publication
(10) Pub. No.: US 2021/0335535 A1
(43) Pub. Date: Oct. 28, 2021

(54) ASSEMBLY FOR A LOW-PROFILE WIRELESS CHARGER

(71) Applicant: Lear Corporation, Southfield, MI (US)

(72) Inventors: Steven CONG, Southfield, MI (US); Ajmal ANSARI, Canton, MI (US); Anthony ARMENTO, Southfield, MI (US); Shane LUERSMAN, Southfield, MI (US)

(21) Appl. No.: 16/859,441

(22) Filed: Apr. 27, 2020

(51) Int. Cl. H01F 27/32; H02J 50/12; H01F 38/14; B60L 53/12

(52) U.S. Cl. CPC H01F 27/325; H02J 50/12; H01F 2038/146; B60L 53/12; H01F 38/14

(57) ABSTRACT

In at least one embodiment, a transformer assembly including a bobbin, a first winding and a second winding is provided. The bobbin defines a first chamber, a second chamber, and a gap. The first winding is positioned in the first chamber. The second winding is positioned in the second chamber. The gap separates the first chamber from the second chamber to cause the first winding and the second winding to generate a leakage inductance such that the leakage inductance and a capacitance of a capacitor that is operably coupled to the transformer assembly generate a resonant frequency to enable inductive mode charging with a vehicle pad.

### TECHNICAL FIELD

Aspects disclosed herein may generally relate to an apparatus for a low-profile wireless charger. This aspect and others will be discussed in more detail below.

### BACKGROUND

U.S. Publication No. 2018/0211766 to Ansari et al. provides an assembly that includes a metallic housing, an electromagnetic (EM) device, and a bobbin in which the EM device is supported. The bobbin has a non-metallic, inner bobbin body, a non-metallic, outer bobbin body, and a metallic shield sandwiched between the inner and outer bobbin bodies. The EM device and the bobbin are mounted in the housing with the bobbin being between the EM device and the housing for heat from the EM device to thermally conduct through the inner and outer bobbin bodies and the shield to the housing while the shield shields noise of the EM device from the housing.

### SUMMARY

In at least one embodiment, a transformer assembly including a bobbin, a first winding and a second winding is provided. The bobbin defines a first chamber, a second chamber, and a gap. The first winding is positioned in the first chamber. The second winding is positioned in the second chamber. The gap separates the first chamber from the second chamber to cause the first winding and the second winding to generate a leakage inductance such that the leakage inductance and a capacitance of a capacitor that is operably coupled to the transformer assembly generate a resonant frequency to enable inductive mode charging with a vehicle pad.

In at least another embodiment, a transformer assembly including a bobbin, a first winding and a second winding is provided. The bobbin defines a gap. The first winding is positioned on the bobbin. The second winding is positioned on the bobbin. The gap separates the first chamber from the second chamber to cause the first winding and the second winding to generate a leakage inductance such that the leakage inductance and a capacitance of a capacitor that is operably coupled to the transformer assembly generate a resonant frequency to enable inductive mode charging with a vehicle pad.

In at least another embodiment, a transformer assembly including a bobbin, a first winding and a second winding is provided. The bobbin defines a gap. The first winding is positioned on the bobbin. The second winding is positioned on the bobbin. The gap separates the first winding from the second winding to cause the first winding and the second winding to generate a leakage inductance. The leakage inductance and a capacitance of a capacitor that is operably coupled to the transformer assembly generate a resonant frequency to enable a base pad to wirelessly transfer power at the resonant frequency to a vehicle pad.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts one example of a front view of assembly for a low-profile wireless charger in accordance to one embodiment;

FIG. 2 depicts a model of the transformer and leakage inductance generated therefrom in accordance to one embodiment;

FIG. 3 depicts a side view of the assembly of FIG. 1 in accordance to one embodiment;

FIG. 4 depicts one example of a bobbin and a magnetic core assembly for the low-profile wireless charger of FIGS. 1 and 3 in accordance to one embodiment;

FIG. 5 depicts one example of a single ferrite core that is provided as a portion of the magnetic core assembly in accordance to one embodiment;

FIG. 6 depicts one example of the bobbin in accordance to one embodiment;

FIG. 7 depicts a perspective view of the assembly for the low-profile wireless charger in accordance to one embodiment; and

FIG. 8 depicts a model of the multiple transformer assemblies and leakage inductance generated therefrom in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

It is recognized that directional terms that may be noted herein (e.g., “upper”, “lower”, “inner”, “outer”, “top”, “bottom”, etc.) simply refer to the orientation of various components of a transformer assembly in connection with the wireless charger as illustrated in the accompanying figures. Such terms are provided for context and understanding of the embodiments disclosed herein.

Wireless chargers may be implemented for 3.7 kW, 7 kW, 11 kW, and 20 kW for various Original Equipment Manufacturers (OEMs). One design challenge may involve providing a design isolation transformer between a direct current (DC)/DC converter and a power transferring unit that provides power to a base pad via various customer requirements. An inverter may be used to invert DC energy into AC energy during a wireless charging operation. In some instances, the inverter may be generally enclosed in an enclosure that is not accessible to users (but for servicing by experienced and trained personnel) from safety point of view. The housing design for the inverter may be different from a normal power supply housing. For example, such a housing may include a window to facilitate air flow to cool electronics for power supply housing. However, the wireless charger itself may not enable the flow of air flow to adequately cool the charger and hence a transformer that forms a portion of the wireless charger. Thus, high power transformer thermal designs may not use air flow as a mechanism to reduce temperature. Thus, one potential thermal dispensation path is the use of a magnetic core that forms the transformer core that is coupled to a metallic housing.

Generally, to reduce cost for a wireless charger housing, the wireless charger may be designed as small as possible. However, this aspect may not allow for the packaging of an independent resonant circuit inductor which is generally required in a resonant inverter design. Thus, this aspect yields a transformer and a resonant inductor with a tight height and horizontal dimension limitation. One way to meet the housing design requirements is to provide an integrated transformer which combines a transformer and a resonant inductor into one transformer. Further, it is possible to utilize a transformer's leakage inductance as the resonant inverter's resonant inductor. Various considerations for such a transformer implementation are to locate a simple solution to balance transformer cost, dimension, turn ratio, magnetizing inductance, leakage inductance and thermal performance.

With a transformer design, the most effective way to higher transformer leakage may include (i) providing more turns in primary and secondary windings under a same turn ratio (ii) with a loose winding, particularly with a larger gap between primary and secondary windings. maintaining turns and a core winding window that is kept unchanged, and (iii) adding a magnetic sheet between the primary and secondary winding to boost the leakage inductance. However, in various desired wireless charger transformer designs, particularly those that are constrained by a housing design with a tight height limitation (i.e., a transformer height constraint), it may not be possible to provide a transformer with more turns or a larger gap between primary and secondary windings of the transformer. In these cases, a low-profile transformer is generally required with a limited winding window.

The winding material used for primary and secondary windings in planar transformer design may be copper foil or a printed circuit board (PCB) board trace winding, both of these winding methods may involve interleaved primary and secondary windings to reduce winding proximity loss. In this case, the primary and secondary winding may have a tight coupling. Such a tight coupling may adversely affect leakage inductance from the transformer's leakage which may otherwise be desirable to use as resonant inductance. The normal solution to boost leakage inductance of a planar transformer may include inserting a magnetic material sheet in between primary and secondary windings. One aspect that requires consideration for the wireless charger is that such a charger may not be able to support air cooling. In general. a high-power transformer magnetic field flux swing may generate an increase in eddy currents based on the inserted magnetic material sheet. The eddy current may generate loss on this sheet. Without air flow cooling, the heat associated with inserted sheet may cause the transformer malfunction.

In order to solve these transformer design considerations, a hybrid transformer design as disclosed herein generally utilizes a low profile-planar E core to replace a copper foil or printed circuit board (PCB) trace winding with a transformer winding Litz wire. This aspect may dramatically reduce winding proximity loss to package the primary and secondary windings together. With no core saturation, it is possible to select less turns for the winding in order to fit into a window area for the lower profile core. Meanwhile, a constant gap between the primary and secondary winding may be held via a transformer bobbin to control the transformer leakage inductance to meet OEM requirements.

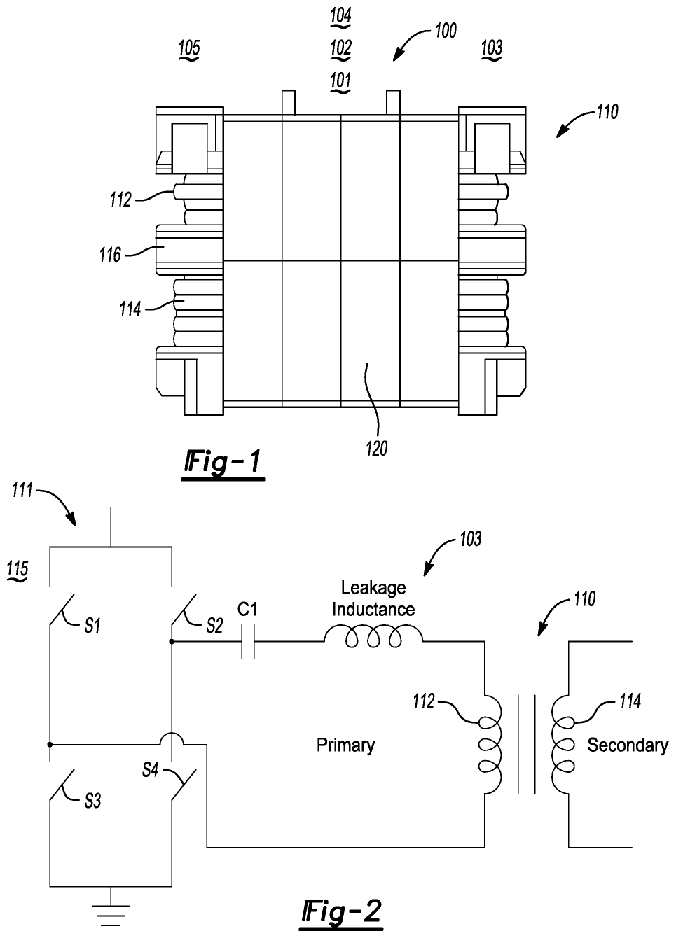

FIG. 1 depicts one example of a front view of assembly 100 for a low-profile wireless charger 102 in accordance to one embodiment. The assembly 100 includes a transformer 101 that may be incorporated into the wireless charger 102 of a vehicle 104. For example, the wireless charger 102 may include a base pad 103 and a vehicle pad 105. The base pad 103 may be positioned below the vehicle 104 (and below the ground) and line up vertically with the vehicle pad 105 when the vehicle 104 is parked over the base pad 103 to perform the wireless charging operation. It is recognized that the transformer 101 as set forth herein may be implemented within the base pad.

In reference back to the assembly 100, the assembly 100 generally includes a bobbin 110, a primary winding (or first winding) 112, and a secondary winding (or second winding) 114. The primary winding 112 is positioned on a first side of the bobbin 110 and the secondary winding 114 is positioned on second side of the bobbin 110 opposite to the first side. A gap 116 is formed on the bobbin 110 between the primary winding 112 and the secondary winding 114 to separate the windings 112 and 114 from one another. The bobbin 110 is generally formed of Nylon based materials and supports the primary winding 112 and the secondary winding 114. In one example, the bobbin 110 may be formed of SLS Glass Filled Nylon.

The primary winding 112 may be implemented as a Litz wire. Similarly, the secondary winding 114 may be implemented as a Litz wire. As shown, the primary winding 112 may be implemented as turns, n₁ around the bobbin 110. Similarly, the secondary winding 114 may be implemented as turns, n₂ around the bobbin 110. The secondary winding 114 may include more or fewer turns than that of the primary winding 112. In one example, the number of turns employed for the primary winding 112 may be 15 turns and the number of turns employed for the secondary winding 114 may be 12 turns. In another example, the number of turns employed for the primary winding 112 may be 12 turns, and the number of turns employed for the second winding 114 may be 15 turns. In general, the number of turns, n₁ for the primary winding 112 may be different than the number of turns, n₁ for the second winding 114. The number of turns employed for the primary winding 112 and the secondary winding 114 aid in meeting power transfer requirements in addition to safety requirements. The utilization of the primary winding 112 and the secondary winding 114 negates the need to cool the transformer 101 since the transformer 101 does not employ a copper foil or PCB solution for purposes of inductive coupling. The Litz wire generally does not generate as much heat as a copper foil and therefore does not require additional cooling mechanisms to reduce the overall temperature of the transformer 101. Additionally, a potted transformer and/or in-directional cooling mechanism may be used to reduce the overall temperature of the transformer 101. The Litz wire may also reduce winding proximity losses.

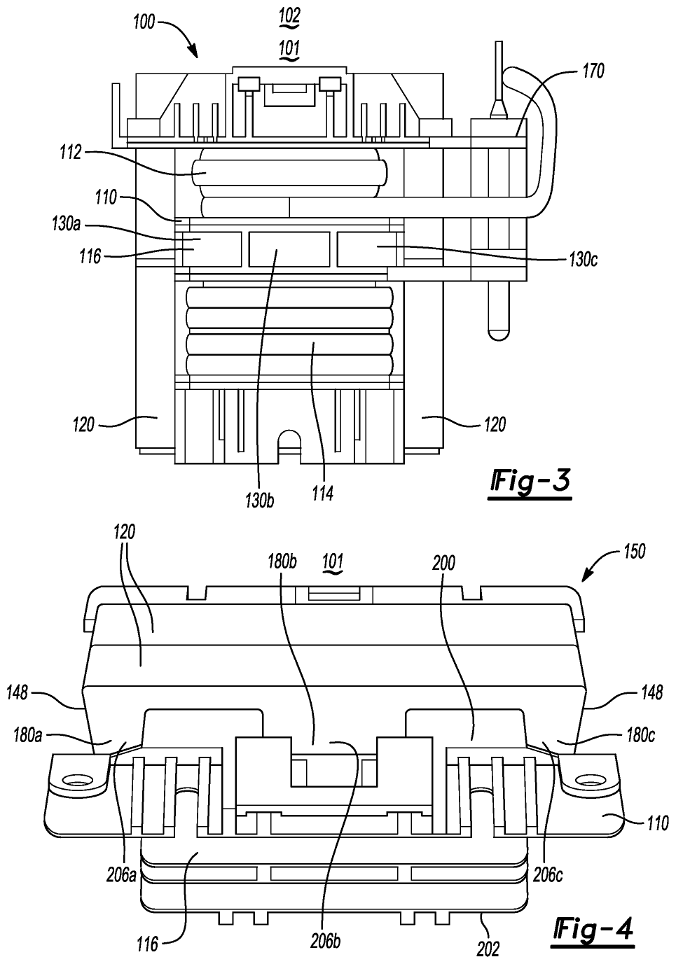

The transformer 101 includes at least one magnetic core (or ferrite core) 120 that is supported by the bobbin 110. FIG. 1 generally illustrates a total of eight cores 120 with four cores 120 being positioned on a front side of the bobbin 110 and four remaining cores 120 being positioned on a back side (not shown) of the bobbin 110. It is recognized that the total number of cores 120 implemented may vary based on the desired criteria of a particular implementation. It is also recognized that the overall size and shape of the magnetic core 120 may vary as well. For example, a single core 120 may be positioned on the front side of the bobbin 110 and another single core 120 may be positioned on the back side (not shown) of the bobbin 110. Each magnetic core 120 includes a high magnetic permeability to confine and guide magnetic fields generated by the primary winding 112 and the secondary winding 114. The magnetic core 120 serves to concentrate the magnetic flux that links the primary winding 120 and the secondary winding 114 together. While not shown in FIG. 1, each magnetic core 120 may be generally e-shaped and include an extending lateral portion 148 (or projecting members 180a, 180c) that extends over the gap 116 on both sides of the transformer 101 (see FIGS. 3 and 4).

The gap 116 as formed on the bobbin 110 and positioned between the primary winding 112 and the secondary winding 114 controls the amount of leakage inductance generated between the windings 112, 114. The gap 116 may extend to a length of 12 mm or less. The particular length selected for the gap 116 to obtain the desired leakage inductance may vary based on power requirements and the type of electrical requirements for a country (or territory) in which the transformer 101 is implemented in. In one example, the gap 116 along with the number of turns, n₁ for the primary winding 112 and the number of turns, n₂ for the secondary winding 114 may generate a leakage inductance in the amount of 25 μH. Such a leakage inductance when in series with a capacitor may provide a resonance frequency for a resonant inverter. In general, the leakage inductance and the capacitor form a resonant network that transfers AC energy at a resonant frequency from the base pad 103 to the vehicle pad 105 for inductive mode charging. The resonant frequency is defined by defined by Fr=½*n*√(L*C)), where L corresponds to the leakage inductance and C corresponds to the capacitance of the capacitor in series with the leakage inductance. In order to maintain a stable resonance frequency, the overall tolerance of the leakage inductance may be in the amount of 1 to 2 μH.

Generally, with transformer designs, it may be preferable to minimize the gap between the primary and secondary sides (or windings 112, 114) of the transformer 101. However, by providing (or increasing the gap) as illustrated in FIG. 1, this aspect increases the amount of leakage inductance that is provided as resonant inductance to drive a capacitor that is coupled in series with the primary windings 112. For example, it is desirable for the resonant frequency of the capacitance and resonant frequency for the inductance to match to enable inductive coupling to occur between the base pad 103 and the vehicle pad 105 as positioned in the vehicle 104. FIG. 2 generally depicts a model of the transformer 101 and the manner in which leakage inductance provided by the transformer 101 impacts a capacitance without the need to incorporate an independent resonant circuit inductor therein. This aspect provides a cost savings over prior art implementations.

For example, FIG. 2 illustrates that the primary winding (or primary inductor) 112 is positioned on a primary side of the transformer 101 and that the secondary winding (or secondary inductor) 114 is positioned on a secondary side of the 101 the transformer. The implementation illustrated in FIG. 2 may be incorporated into the base pad 103. Due to the gap 116 formed on the bobbin 110 and further based on the number of turns of the Litz wires that form the primary winding 112 and the secondary winding 114, the transformer 101 generates a predetermined amount of leakage inductance (e.g., Leakage Inductance) which may be for example, 25 μH. The leakage inductance and the capacitor C1 provide a resonant frequency for a resonant inverter 111. The resonant inverter 111 generally includes a plurality of switches (S1-S4) that are selectively activated via a controller 115 to convert DC energy into AC energy. As noted above, the capacitor C1 and the leakage inductance form a resonant network for inductively transferring the AC energy from the base pad 103 to the vehicle pad 105 at a resonant frequency to enable inductive mode charging.

The utilization of the leakage inductance from the transformer 101 as opposed to utilizing a resonant inductor as traditionally implemented may provide various advantages. For example, by avoiding the use of a resonant inductor, such a condition provides a smaller package size for the transformer 101 and also reduces overall cost. Further, resonant inductors generally include a +/−30% tolerance with respect to the overall inductance value. Such a large variation with respect to the overall inductance may adversely impact charging (i.e., overall charging efficiency) between the base pad 103 and the vehicle pad 105. The utilization of the leakage inductance from the gap 116 of the bobbin 110 provides a more stable and predictable inductance value by way of the leakage inductance to ensure proper resonant frequency.

FIG. 3 depicts a side view of the assembly 100 of FIG. 1 in accordance to one embodiment. In the embodiment illustrated, the magnetic cores 120 are positioned behind the bobbin 110. A plurality of terminals 170 are coupled to the bobbin to secure ends of the Litz wire that forms the primary winding 112 and the Litz wire that forms the secondary winding 114. In one example, there may be two terminals that are provided to receive and couple a first end of the Litz wire and a second end of the Litz wire that forms the primary winding 112. Additionally, there may be two additional terminals that are provided to receive and couple a first end of the Litz wire and a second end of the Litz wire that forms the secondary winding 114. While FIG. 3 depicts only a single terminal 170, it is recognized that any number of terminals 170 may be provided on the bobbin 110. In general, all of the shapes and features illustrated in FIG. 3 except for the primary winding 112, the secondary winding 114, and the terminal 170 form the bobbin 110.

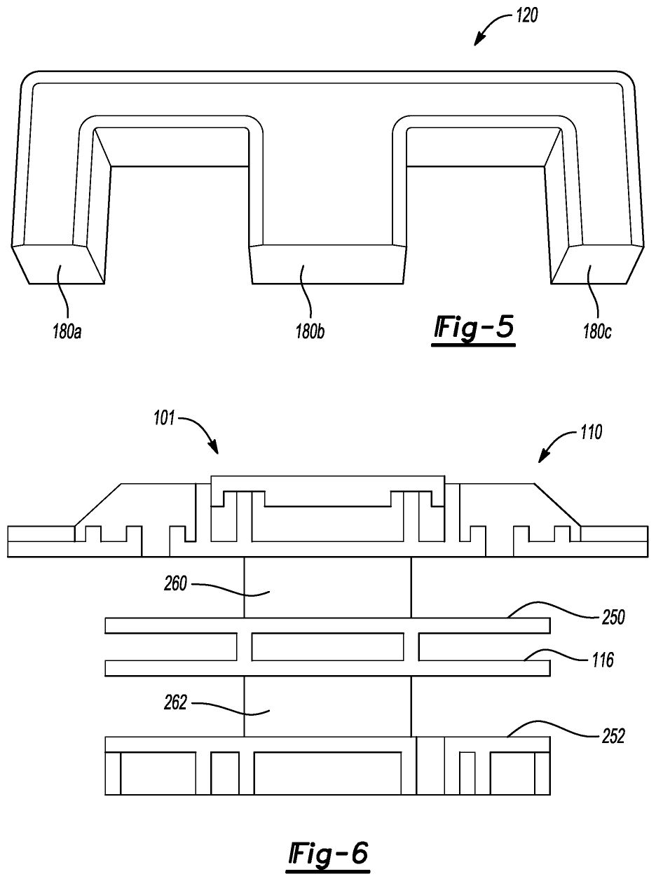

FIG. 4 depicts a tilted view of one example of the bobbin 110 and a magnetic core assembly 150 for the low-profile wireless charger of FIGS. 1 and 3 in accordance to one embodiment. The magnetic core assembly 150 generally includes any number of the magnetic cores 120. As noted above, in one example, there may be a single magnetic core 120 that is positioned on one side of the bobbin 110 and another single magnetic core 120 that is positioned on another side of the bobbin 110 for a total of two magnetic cores 120 that are positioned on the bobbin 110. For the embodiment illustrated in FIG. 4, a total of two magnetic cores 120 are illustrated on a first side 200 of the bobbin 110. However, it is recognized in this example, a total of three magnetic cores 120 may be positioned on the first side 200 of the bobbin 110 and an additional number of three magnetic cores 120 may be positioned on a second side 202 of the bobbin 110. FIG. 5 illustrates one example of a single magnetic core 120 in accordance to one embodiment. As shown, each corresponding magnetic core 120 may be E-shaped. In general, the magnetic core 120 may include first projecting member 180a, a second projecting member 180b, and a third projecting member 180c.

Referring back to FIG. 4, the bobbin 110 defines a first outer channel 206a, a center channel 206b, and a second outer channel 206c. The first projecting member 180a may be positioned within the first outer channel 206, the second projecting member 180b may be positioned within the center channel 206b, and the third projecting member 180c may be positioned within the second outer channel 206c. This is generally the case for all of the first, second and third projecting members 180a, 180b, 180c for each of the magnetic cores 120 positioned on the bobbin 110.

FIG. 6 depicts one example of the bobbin 110 in accordance to one embodiment. The bobbin 110 generally defines a primary chamber 250 for receiving the primary winding 112 (or Litz wire) and a secondary chamber 252 for receiving the secondary winding 114 (or Litz wire). A first center extending section 260 is positioned in the primary chamber 250 to enable the primary winding 112 (e.g., the Litz wire) to form any number of turns within the primary chamber 250 (e.g., the Litz wire may be wrapped around the first center extending section 260). A second center extending section 262 is positioned in the secondary chamber 252 to enable the secondary winding 112 (e.g., the Litz wire) to form any number of turns within the secondary chamber 252 (e.g., the Litz wire may be wrapped around the second center extending section 262). The overall profile or outer geometry of the bobbin 110 itself may be rectangular with the overall length of the front and rear facing sides of the bobbin 110 as illustrated in FIG. 6 being shorter than the overall length of the two opposing sides of the bobbin 110. This aspect is shown in FIG. 3.

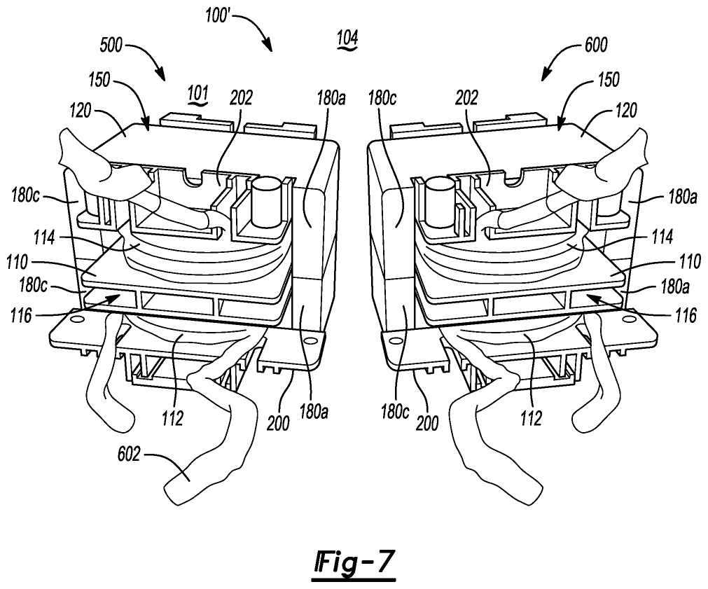

FIG. 7 depicts a perspective view of multiples assemblies 100′ (e.g., a first assembly 500 and a second assembly 600) for the low-profile wireless charger in accordance to one embodiment. The view of the assemblies 500 and 600 in FIG. 7 is rotated upside down relative to the previous views illustrated. The multiple assemblies 100′ may be coupled together via the primary windings 114. For example, the first assembly 500 may be coupled to the second assembly 600 via a connection 602 formed between the primary windings 114 of the first assembly 500 and the second assembly 600. Each of the first assembly 500 and the second assembly 600 may be positioned in the base pad 103 for inductively communicating with the vehicle pad 105 to charge one or more batteries of the vehicle 104.

It is shown the primary winding 112 is positioned in the primary chamber 250 and that the secondary winding 114 is positioned in the secondary chamber 252. As shown, a first plurality of magnetic cores 120 are positioned on the second side 202 of the bobbin 110. A second plurality of magnetic cores 120 are positioned on the first side 200 of the bobbin 110. In the embodiment illustrated in FIG. 7, there may be a total of three magnetic cores 120 that form the first plurality of magnetic cores 120 and that there may be a total of three magnetic cores 120 that form the second plurality of cores 120. It is recognized that the number of magnetic cores 120 implemented on the assembly 100′ may be vary based on the particular implementation of a desired application. For example, the number of magnetic cores 120 may vary based on charging requirements (e.g., power charging requirements, etc.). Assuming for example that each assembly 500, 600 is generally shaped in the form of a cube with eight sides, the magnetic cores 120 are arranged on a total of four sides (or surround) the primary coil 112 and the secondary coil 114. In this case, opposing ends (e.g., the first, second and third projecting members 180a, 180b, 180c) of the first and the second plurality of magnetic cores 120 generally are adjacent to and contact each other such that the first and the second plurality of cores 120 surround the primary coil 112 and the secondary coil 114 on four sides of the bobbin 110.

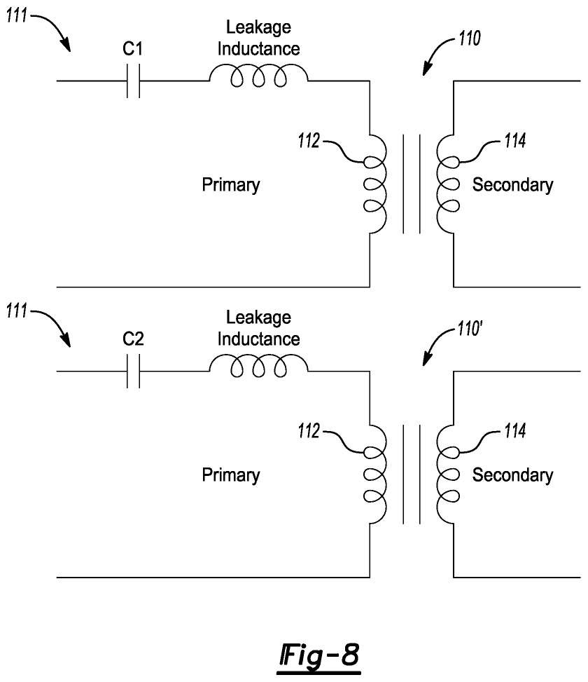

FIG. 8 depicts a model of the multiple assemblies and leakage inductance generated therefrom in accordance to one embodiment. In general, the first assembly 500 includes the transformer 110 having a first capacitor (e.g., C1) that is in series with the leakage inductance generated from the primary winding 112 and the secondary winding 114 while separated by the gap of the bobbin 110. The second assembly 600 includes the transformer 110′ having a second capacitor (e.g., C2) that is in series the leakage inductance generated from the primary winding 112 and the secondary winding 114 while separated by the gap of the bobbin 110. It is recognized that the first assembly 500 and the second assembly 600 may each include a corresponding inverter 111 as illustrated in connection with FIG. 3. In general, the utilization of a single assembly 100 or multiple assemblies 100′ may depend on a desired power level for the wireless charger and overall housing dimension. With a two-transformer implementation (e.g., the first assembly 500 and the second assembly 600), the leakage inductance from both of the transformers 100 and 100′ along with the capacitors C1 and C2, (in series with the leakage inductance) transmit the AC energy from the inverters 111 (i.e., from both transformers 100 and 100′) at a resonant frequency from the base pad 103 to the vehicle pad 105.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A transformer assembly comprising:
a bobbin defining a first chamber, a second chamber, and a gap;
a first winding positioned in the first chamber; and
a second winding positioned in the second chamber;
wherein the gap separates the first chamber from the second chamber to cause the first winding and the second winding to generate a leakage inductance such that the leakage inductance and a capacitance of a capacitor that is operably coupled to the transformer assembly generate a resonant frequency to enable inductive mode charging with a vehicle pad.

2. The transformer assembly of claim 1, wherein the first winding includes a first Litz wire.

3. The transformer assembly of claim 2, wherein the second winding includes a second Litz wire that is separate from the first Litz wire.

4. The transformer assembly of claim 3, wherein the first Litz wire has a first number of turns, n₁ and the second Litz wires has a second number of turns, n₂; where n₁ is different from n₂.

5. The transformer assembly of claim 1 further comprising at least one first magnetic core positioned about a first side of the bobbin.

6. The transformer assembly of claim 5 further comprising at least one second magnetic core positioned about a second side of the bobbin, wherein the first side is positioned opposite to the second side and wherein the at least one first magnetic core and the at least one second magnetic core abut one another.

7. The transformer assembly of claim 6, wherein each of the at least one first magnetic core and the at least one second magnetic core includes a plurality of projecting members.

8. The transformer assembly of claim 7, wherein the bobbin defines a first outer channel at a first outer portion thereof, a second outer channel at a second outer portion thereof, and a center channel positioned between the first outer portion and the second outer portion.

9. The transformer assembly of claim 8, wherein each of the first outer channel, the second outer channel, and the center channel receive a corresponding projecting member from each of the at least one first magnetic core and the at least one second magnetic core.

10. The transformer assembly of claim 1 wherein:
the first chamber is generally planar to receive the first winding; and
the second chamber is generally planar to receive the second winding.

11. The transformer assembly of claim 10, wherein the first chamber is axially spaced apart from the second chamber.

12. A transformer assembly comprising:
a bobbin defining a gap;
a first winding positioned on the bobbin; and
a second winding positioned on the bobbin;
wherein the gap separates the first winding from the second winding to cause the first winding and the second winding to generate a leakage inductance such that the leakage inductance and a capacitance of a capacitor that is operably coupled to the transformer assembly generate a resonant frequency to enable inductive mode charging with a vehicle pad.

13. The transformer assembly of claim 12, wherein the first winding includes a first Litz wire.

14. The transformer assembly of claim 13, wherein the second winding includes a second Litz wire that is separate from the first Litz wire.

15. The transformer assembly of claim 14, wherein the first Litz wire has a first number of turns, n₁ and the second Litz wires has a second number of turns, n₂; where n₁ is different from n₂.

16. The transformer assembly of claim 12 further comprising at least one first magnetic core positioned about a first side of the bobbin.

17. The transformer assembly of claim 16 further comprising at least one second magnetic core positioned about a second side of the bobbin, wherein the first side is positioned opposite to the second side and wherein the at least one first magnetic core and the at least second magnetic core abut one another.

18. A transformer assembly comprising:
a bobbin defining a gap;
a first winding positioned on the bobbin; and
a second winding positioned on the bobbin;
wherein the gap separates the first winding from the second winding to cause the first winding and the second winding to generate a leakage inductance such that the leakage inductance and a capacitor that is operably coupled to the transformer assembly generate a resonant frequency to enable a base pad to wirelessly transfer power to a vehicle pad.

19. The transformer assembly of claim 18, wherein the first winding includes a first Litz wire, and the second winding includes a second Litz wire that is separate from the first Litz wire.

20. The transformer assembly of claim 19, wherein the first Litz wire has a first number of turns, n₁ and the second Litz wires has a second number of turns, n₂ where n₁ is different from n₂.
